(19) United States
(12) Patent Application Publication
(10) Pub. No.: US 2011/0210548 A1
(43) Pub. Date: Sep. 1, 2011

(54) CONTROL SYSTEM FOR EXTRACTING POWER FROM WATER FLOW

(76) Inventors: Conrad SEVENSTER, Victoria (AU); Tim Cornelius, Singapore (SG); Gary Campbell, Mtntone (AU)

(21) Appl. No.: 12/784,996

(22) Filed: May 21, 2010

Related U.S. Application Data
(63) Continuation of application No. PCT/AU2008/001737, filed on Nov. 24, 2008.

(30) Foreign Application Priority Data
Nov. 23, 2007 (AU) 2007906438

(51) Int. Cl. F03B 15/00

(52) U.S. Cl. 290/43

(57) ABSTRACT

A system for controlling operation of a water turbine is described, the system comprising, a turbine; means for measuring an activity affecting operation of the turbine; means for altering operation of the turbine; and a data processing apparatus comprising a central processing unit (CPU), a memory operably connected to the CPU, the memory containing a program adapted to be executed by the CPU, wherein the CPU and memory are operably adapted to receive information from the measuring means and implement an instruction to the altering means to alter the operation of the turbine. Data processing systems, computer program elements and methods for controlling operation of the turbine are also described.

### FIELD OF THE INVENTION

The invention relates generally to systems and methods for controlling operation of water turbines.

### BACKGROUND OF THE INVENTION

It is known to generate power from flows of water. However, many known systems for generating power from water flows are not easily controlled or susceptible to control. In order to connect to an electricity grid, it is useful to have predictable and controllable power outputs. Furthermore, water environments include unpredictable elements such as large and small marine life, dirt, silt, growths, and other complicating factors. Control systems to date have not been able to deal with these kind of output risk factors.

The present invention seeks to ameliorate one or more of the above-mentioned disadvantages.

### DISCLOSURE OF THE INVENTION

In a first aspect, the present invention provides a system for controlling operation of a water turbine comprising:

a turbine;

means for measuring an activity affecting operation of the turbine;

means for altering operation of the turbine; and

a data processing apparatus comprising a central processing unit (CPU), a memory operably connected to the CPU, the memory containing a program adapted to be executed by the CPU, wherein the CPU and memory are operably adapted to receive information from the measuring means and implement an instruction to the altering means to alter the operation of the turbine.

Preferably, the system controls the turbine to optimize power generation in a given water flow rate. Typically, the flow rate is less than about 10 knots, less than about 8 knots, less than about 6 knots or between about 1 and 5 knots. The water flow rate may be tidal, river flow, outflow, or current in an ocean or sea. The present invention is particularly suitable for controlling a water turbine installed in an environment with low flow rates of less than about 5 knots to provide optimum power or electricity generation. The system can be used to control a turbine up to about 8 knots.

The turbine may be selected from any suitable turbine such as axial turbine, track-based turbine and slew-ring turbine. Preferably, the turbine is a track-based turbine such as those described in WO 2005/028857, WO 2005/119052 and WO 2007/070935 (Atlantis Resources Corporation Pte Limited).

The turbine may have one power take off running one or more generators or multiple power take offs running multiple generators.

Preferably, the activity affecting output of the turbine is selected from water velocity (rate), water flow direction, relative position to water flow, load, torque, height or position in water, rotor blade or foil speed, rotor blade or foil lift, rotor blade or foil drag, torque, power output, electricity generated, power load, or the like.

Preferably, the turbine is altered by one or more of positioning relative to water flow direction, adjusting height or depth, orientation, altering rotor blade or foil speed, altering power load, altering torque, transfer of power, or the like.

Preferably, the power load is altered using a variable speed drive (VSD) positioned in association with the turbine or system. In one preferred arrangement, the VSD is located on the pylon or mounting structure of the power generating system. The VSD preferably controls or monitors power to the generator to affect load or torque.

There are some situations where external power can be used to initiate or continue rotor rotation at a minimum or desired speed to ensure optimum power generation. As a turbine system is attached to a power grid, the control system can initiate the drawing of power from the grid to power up the turbine if required.

Preferably the means for measuring an activity is one or more of the following and may be in combination with others of the following: a sonar device for detecting potential or actual obstructions; means for measuring an activity in the form of a current profiler; a thermocouple for measuring the temperature of ambient air or ambient water or motor temperature, or hydraulic oil temperature; a transducer receiving angular or height measurements relating to yaw or linear positioning of the turbine; one or more underwater or above-water cameras for detecting potential or actual obstructions; one or more transducers for measuring turbine speed or power generated, volts generated, phase generated; tide information; a fuse, connection or relay check routine; and combinations thereof.

In preferred embodiments the means for altering an operation of the turbine may be one or more of the following: a hydraulic motor for changing a yaw angle or height of the turbine above sea bed level; a generator or inverter to change a torque input to the turbine to affect its speed; an alarm; and combinations thereof.

In a second aspect, the present invention provides a system for controlling operation of a water turbine comprising:

a turbine;

means for measuring water velocity (flow rate);

means for measuring water flow direction;

means for measuring turbine load or output;

means for measuring turbine speed;

means for measuring angle of attack of turbine blades or foils; means for measuring turbine height; and

a data processing apparatus comprising a central processing unit (CPU), a memory operably connected to the CPU, the memory containing a program adapted to be executed by the CPU. wherein the CPU and memory are operably adapted to receive information from the water flow velocity (rate) measuring means, the water flow direction measuring means, the turbine load or out measuring means, the turbine speed measuring means, the height of the turbine, the orientation of the turbine and implement an instruction to control operation of the turbine.

Preferably, the instruction is selected from increase torque, decrease torque, alter direction of turbine, alter height of turbine, alter orientation of turbine, alter blade or foil angle, alter angle of attack, alter VSD activity, couple or decouple generator, draw power from grid, send power to grid, and the like.

In a third aspect, the present invention provides a data processing apparatus for controlling operation of a water turbine comprising

a central processing unit (CPU);

a memory operably connected to the CPU, the memory containing a program adapted to be executed by the CPU, wherein the CPU and memory are operably adapted to receive information on an activity affecting operation of a turbine and send an instruction to alter the operation of the turbine.

Preferably, the data processing apparatus further stores the information received on the activity affecting operation of a turbine, information received and/or information on the output or operation of the turbine.

Preferably, the data processing unit is a programmable logic controller (PLC).

Preferably the information on the activity affecting operation of the turbine is one or more of the following: a sonar device for detecting potential or actual obstructions; a current profiler, a thermocouple for measuring the temperature of ambient air; or ambient water, or motor temperature, or hydraulic oil temperature; a transducer receiving angular or height measurements relating to yaw or linear positioning of the turbine; one or more underwater or above-water cameras for detecting potential or actual obstructions; one or more transducers for measuring turbine speed or power generated, volts generated, phase generated; tide information; a fuse, connection or relay check routine; a hydraulic motor for changing a yaw angle or height of the turbine above sea bed level; a generator or inverter to change a torque input to the turbine to affect its speed; an alarm; and combinations thereof.

In a fourth aspect, the present invention provides a data processing apparatus for controlling operation of a water turbine comprising:

a central controller including a central processing unit (CPU) and memory operably connected to the CPU;

at least one terminal, adapted for communicating with the central controller for transmitting information on activity of a water turbine;

the memory in the central controller containing a program adapted to be executed by the CPU, for receiving information on an activity affecting operation of a turbine and sending an instruction to the terminal to alter the operation of the turbine.

Preferably, the apparatus contains a plurality of terminals with each terminal in communication with a separate turbine or collection of turbines.

Preferably, the central controller further stores the information received on the operation of a plurality of turbines.

The central controller may be hardwired to the terminals or in remote access by telephone. radio or the like.

In a fifth aspect, the present invention provides a method for controlling operation of a water turbine with the aid of a computer comprising:

receiving information on an activity affecting operation of a turbine; analyzing the received information; and

sending an instruction based on the received information to alter the operation of the turbine.

Preferably the information on the activity affecting operation of the turbine may be one or more of the following: a sonar device for detecting potential or actual obstructions; a current profiler, a thermocouple for measuring the temperature of ambient air; or ambient water, or motor temperature, or hydraulic oil temperature; a transducer receiving angular or height measurements relating to yaw or linear positioning of the turbine; one or more underwater or above-water cameras for detecting potential or actual obstructions; one or more transducers for measuring turbine speed or power generated, volts generated, phase generated; tide information; a fuse, connection or relay check routine; a hydraulic motor for changing a yaw angle or height of the turbine above sea bed level; a generator or inverter to change a torque input to the turbine to affect its speed; an alarm; and combinations thereof.

In a sixth aspect, the present invention provides a computer readable memory, encoded with data representing a programmable device, comprising:

means for receiving information on an activity affecting operation of a turbine; means for analyzing the received information; and

means for sending an instruction based on the received information to alter the operation of the turbine.

Preferably the information on the activity affecting operation of the turbine is one or more of the following: a sonar device for detecting potential or actual obstructions; a current profiler, a thermocouple for measuring the temperature of ambient air; or ambient water, or motor temperature, or hydraulic oil temperature; a transducer receiving angular or height measurements relating to yaw or linear positioning of the turbine; one or mare underwater or above-water cameras for detecting potential or actual obstructions; one or more transducers for measuring turbine speed or power generated, volts generated, phase generated; tide information; a fuse, connection or relay check routine; a hydraulic motor for changing a yaw angle or height of the turbine above sea bed level; a generator or inverter to change a torque input to the turbine to affect its speed; an alarm; and combinations thereof.

In a seventh aspect, the present invention provides a computer program element comprising a computer program code to make a programmable device:

receive information on an activity affecting operation of a water turbine;

analyze the received information; and

send an instruction based on the received information to alter the operation of the turbine.

In an eighth aspect, the present invention provides a method of generating power from flow of water comprising:

installing a power system according to the first or second aspects of the present invention in a region having flowing water;

allowing flow of water to turn the turbine; and

altering the power output of the turbine using the system to produce electricity.

Throughout this specification, unless the context requires otherwise, the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed in Australia before the priority date of the invention disclosed in this specification.

In order that the present invention may be more clearly understood, preferred embodiments will be described with reference to the following drawings and examples.

### BRIEF DESCRIPTION OF THE DRAWINGS

FIG. 1 shows schematic of a control system for a water turbine according to the present invention.

FIG. 2 shows schematic of another control system for a water turbine according to the present invention;

FIG. 3 is a schematic diagram showing components of a control system of one preferred embodiment of the present invention;

FIG. 4 is a schematic diagram showing components of a control system of a preferred embodiment of the present invention; and

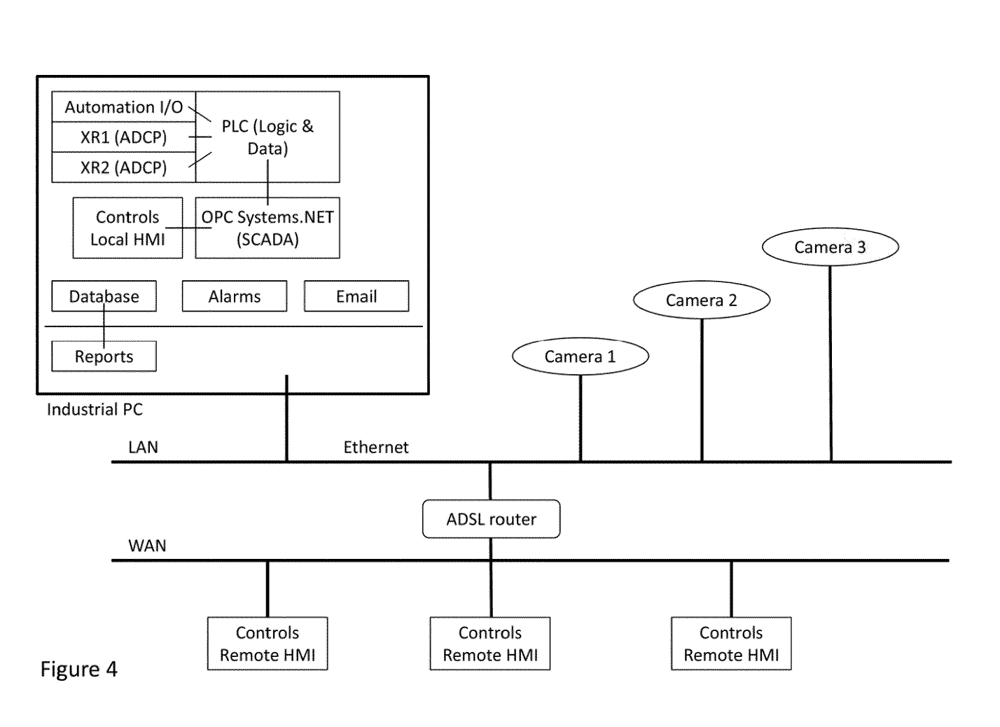

FIG. 5 is a schematic diagram showing components of a processing system.

### MODE(S) FOR CARRYING OUT THE INVENTION

Underwater power generation systems typically contain a turbine having a number of blades or foils. The system includes a power extraction device such as a generator or pump to generate power and rotation or movement of the blades or the foils under the influence of water pressure or lift causes power to be generated through the power extraction device. In its simplest form, rate of movement or rotation of the turbine is proportional to the movement or flow rate of the water that passes over or through the turbine. If the flow rate is too low, then the turbine will not function and no power is generated. Similarly, if the flow rate is irregular or inconsistent, the rate of power generation will also be irregular or inconsistent.

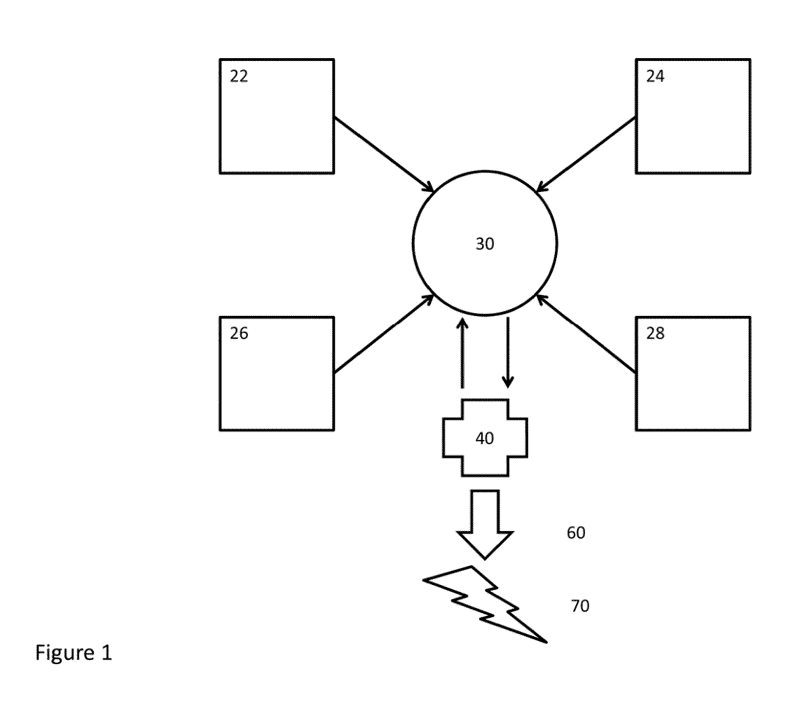

An example of the system for controlling operation of a water turbine according to the present invention is set out in FIG. 1 Turbine 40 is connected to power grid 70 and is capable of generating electricity and transferring the electricity via link 60 to the power grid 70. The turbine 40 can be any suitable arrangement that can operate under the influence of water movement. Examples include, but not limited to axial turbines similar to wind turbines such as described in WO 00/50768 (Marine Current Turbines Limited), track-based turbines such as those described in WO 2005/028857. WO 2005/119052 and WO 2007/070935 (Atlantis Resources Corporation Pte Limited), slew-ring turbines such as described in EP 1 430 220 (Clean Current Power Systems Incorporated). The present invention has been trialed with a track-based turbine and is particularly suitable for such a system.

The operation of the turbine 40 is carried out by control system 30 which receives and processes information from a number of measuring means 22, 24, 26, 28. Examples of the measuring means 22, 24, 26, 28 can measure water velocity, flow rate, water flow direction, turbine load or output, turbine speed, angle of attack of turbine blades or foils, and the like. Specific apparatus to make the measurements can be placed in the immediate environment of the turbine 40 and relay those measurements or information to the control system. Information from the measuring means 22, 24, 26, 28 are fed to control system 30 and output of the turbine 40 is controlled on the basis of the information processed. Specific software has been developed that allows information to be processed and signals or instructions sent to the turbine 40 to optimize its output in a given environment.

In one example, the control system 30 has a programmable logic controller (PLC and is associated with the turbine 40 which includes a variable speed drive (VSD) adapted to control the rotational speed of the turbine in order to provide optimum power output. The PLC is adapted to regulate the operating speed and torque of the turbine 41 using the VSD, so as to maintain optimum power output for a given water flow rate.

The system may further include a kick start function to initiate or increase rotation of the turbine when flow rate is low or to overcome resistance to rotation of the turbine under high or low input situations.

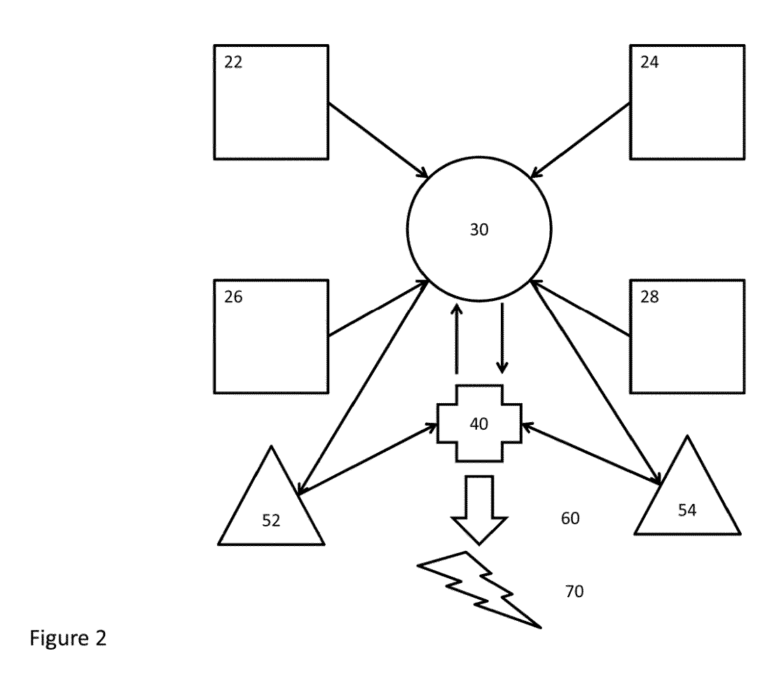

FIG. 2 shows a similar arrangement to the system of FIG. 1 but further including external altering means 52 and 54 for turbine 40. Examples of altering means 52 and 54 include positioning turbine 40 relative to water flow direction, adjusting height or depth of turbine 40, altering rotor blade or foil speed of turbine 40. altering power load or torque applied to turbine 40. A variable speed drive (VSD) can be used to apply anti-torque to the turbine 40 to maintain the desired movement to optimize power generation.

For turbines that require specific positioning regarding the direction of water flow, such as for example track-based systems, an altering means can be a stewing arrangement to focus or aim the turbine 40 relative to water flow direction.

The system may further include a kick start function to initiate or increase rotation of the turbine when flow rate is low or to overcome resistance to rotation of the turbine under high or low input situations. In this regard, power would be drawn from the power grid 70 to turn the turbine 40 by a motor arrangement. Some forms of generators can generate power via rotation of the turbine 40 but can also be used as a motor to turn a turbine 40 via power received form the power grid 70. The control system 30 can control supply of electricity to or from the generator as required.

The control system 30 can be placed in close proximity to the system 10 and be hardwired to the measuring means 22, 24, 26, 28, altering means 52. 54 and turbine 40. Alternatively, the control system 30 can be remote and in communication by radio network or other communications network such as for example the internet. The control system 30 can control a single turbine or operate a series of turbines in a water turbine farm.

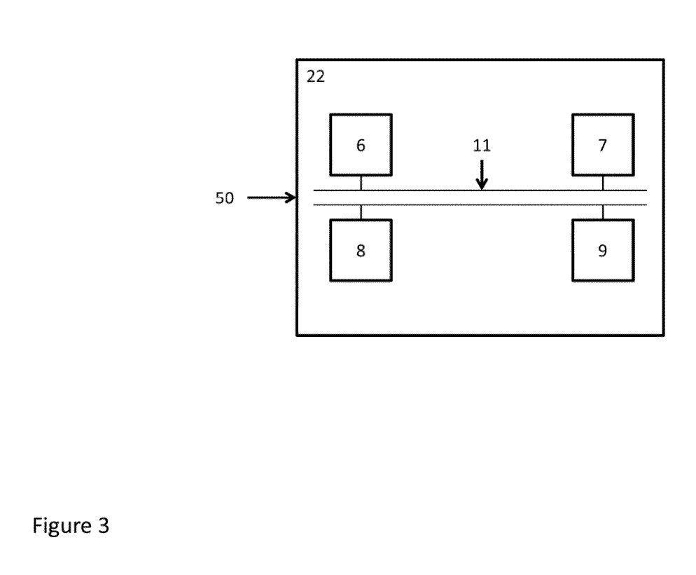

The control system 30 includes a processing system 50 which includes a distributed architecture, an example of the latter being shown at FIG. 3. In this example, a base station 1 is coupled to a number of end stations 3 and 5 via a communications network 2, such as for example the Internet, and/or wireless or radio networks, and/or via communications networks 4, such as local area networks (LANs) 4. Thus it will be appreciated that the LANs 4 may form an internal network at a specific location.

In use, the processing system 50 is adapted to receive information from at least the measuring Means 22-26 and/or other means such as websites or control inputs, and supply this to the end stations 3, 5 in the form of a user or controller's terminal. The or each end station 5 is adapted to provide information back to the base station 1.

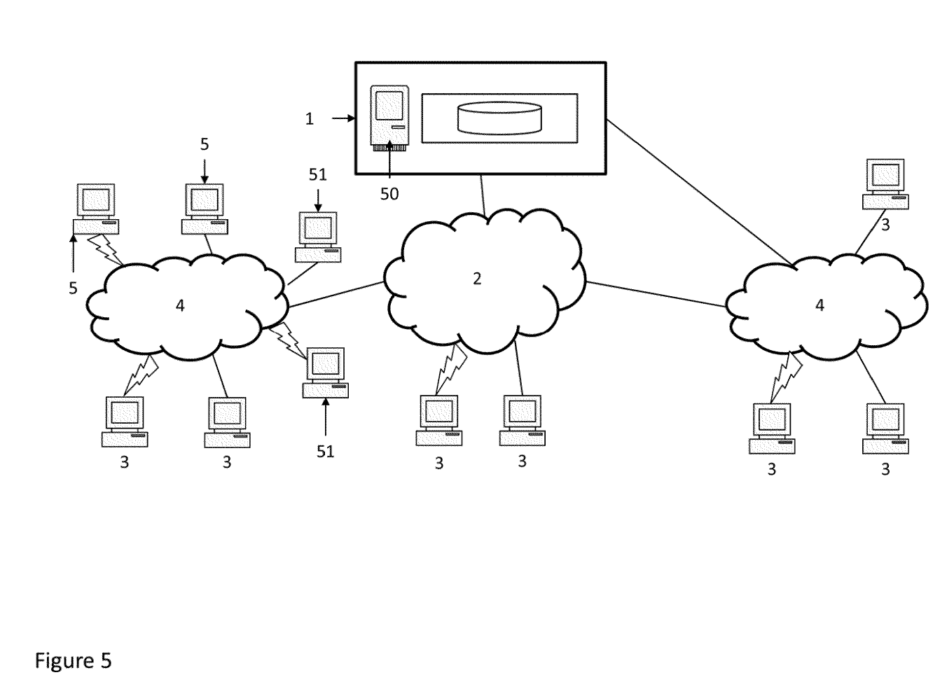

Accordingly, any form of suitable processing system 50 may be used. An example is shown in FIG. 5. In this example, the processing system 50 includes at least a processor 6, a memory 7, an input/output device 8, such as for example a keyboard and display, and an external interface 9 coupled together via a bus 11 as shown.

Accordingly it will be appreciated that the processing system 50 may be formed from any suitable processing system, such as for example a suitably programmed PC, PLC, internet terminal, laptop, hand held PC or the like which is typically operating applications software to enable data transfer and in some cases web browsing.

Similarly the or each end station 3 must be adapted to communicate with the processing system 50 positioned at the base station 1. It will be appreciated that this allows a number of different forms of end station 3 to be used.

Measuring means or inputs 22, 24, 26, 28 may include cameras or other detection means such as sonar and those inputs as herein described on the pages of this description. Sonar and underwater and above-water cameras can be utilised and their outputs can be remotely monitored over the communications network. In this way, certain kinds of obstruction can be detected by an operator or computer who can remotely stop the turbine or alter the turbine performance in some appropriate manner. The detection means, sonar or cameras may also be connected to an alarm and an emergency automatic stop. Software such as for example shape recognition software can also be utilised so that potential obstructions can be automatically detected, and the control system 30 can then actuate certain other devices automatically in response. In certain circumstances, action can be taken by the control system 30 in response to certain Potential hazards, such as the actuation of an alarm or a change in the operating speed or angle or height of the turbine 40, until the potential or actual obstruction has been removed or has removed itself. At that time the absence of the obstruction can also be detected by the cameras or sonar or other detection means arid the turbine 40 can be actuated automatically to recommence generation of power.

Furthermore, footage from the camera or the events from the sonar can be recorded by the memory. For increased efficiency of data storage, other time periods where no events occur may be deleted from memory, however, a selected time period before and after an obstruction event may be retained in the memory for later review.

Inputs 22, 24, 26, 28 may also include current profilers in the form of Acoustic Doppler Current Profilers (ADCPs) which report to the control system 30 the following information:

10 laminar water layers of water velocity

10 laminar water layers of water direction

Average water velocity

Average water direction

Tide depth

The abovementioned information is logged to an SQL server database.

The ADCPs are integrated into a PLC control system and their outputs may be utilized in the processor so that it, through an actuation signal, causes actuation of an element such as a hydraulic motor so that the height or yaw angle of the turbine 30 may be changed to optimise output. If the tide reverses direction the control system makes what is known as a Major movement (180 degrees rotation) and if the tide changes direction by a few degrees the control system makes what is known as a Minor movement to optimise the power output.

The control system also maintains secure access to all outputs. Access to the control system is password-protected, which in preferred embodiments is useful because the communications network facilitates access from anywhere the internet or other satellite-enabled communication device is disposed.

The control system 30 monitors and controls various levels of power including PLC links to relays for various devices, fuses and switches, and also controls and monitors high-voltage outputs to control the phase angles and magnitudes of power entering the power grid 70.

In order to increase reliability, 24V circuits are preferably employed in computing circuits, UPS, sensors and I/O controls. Furthermore, redundant power supplies are installed in the control system 30. Each power supply is connected to a Diode module and if one power supply fails or faults, this fault condition is contained behind the diode module allowing the other power supply to continue operating. Each power supply has a fault signaling contact wired into the PLC I/O so notification of the fault can be detected and repaired.

Fuses can be reset remotely by PLC outputs. This is useful in preferred embodiments because they are usually located in a cabinet in a remote location offshore on a pylon.

Power supplies are provided, in the form of batteries which can be recharged by a solar panel or other method such as tapping the tidal power from the turbine 40.

The control system may also generate reports upon request relating to tidal flow, tidal angle, power generated, events log.

Other measuring means connected to the PLC include flooded motor chamber detector; thermocouple for motor temperature; thermocouple for air temperature; tachometer for turbine, devices for measuring motor torque, frequency, volts, amps, power, RPM. The PLC is also connected to the hydraulic motors which move the turbine along the pylon and around the pylon. Positioning measuring devices are also connected so that accurate readings and positions can be obtained.

Software provides a Graphical Interface so as to provide the following information and capability to any user or controller location in the world; data from power generation; manual override of torque setting; manual override of height and angle of turbine 40; views of real-time power generation statistics; views of previous time-periods of power generation; views of camera images; views of tide tables; views of tide laminae in real time; alarm log.

The present inventors have extensively modelled the power output of water turbines and have developed suitable control systems 10 based on this information. It has been found that even subtle or sensitive manipulation of environmental factors can allow optimum power generation, even from low water flow rates. A set point can be calculated for a given flow rate and type of turbine so that the control system 10 can be programmed to maintain the speed of turbine to maximize output in that flow rate.

The present invention has been used by the applicant to successfully control and optimize the power generation of a track-based water turbine connected to a power grid.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1.-20. (canceled)

21. A system for controlling operation of an underwater power generator comprising:
an underwater turbine;
meters for measuring an activity affecting operation of the turbine;
drives for altering operation of the turbine; and
a data processing apparatus comprising a central processing unit (CPU), a memory operably connected to the CPU, the memory containing a program adapted to be executed by the CPU, wherein the CPU and memory are operably adapted to receive information from the measuring means and implement an instruction to the altering means to alter the operation of the turbine, wherein the meters for measuring an activity is selected from the group consisting of: an ADCP current profiler; a thermocouple for measuring the temperature of motor, or hydraulic oil; a network connection for receiving tide information; and combinations thereof.

22. The system as defined in claim 1 wherein the drives for altering an operation of the turbine is selected from the group consisting of a motor for changing a yaw angle or height of the turbine above sea bed level; a motor or generator or inverter or brake to change a torque input to the turbine to affect its speed; an alarm; and combinations thereof.

23. A system for controlling operation of an underwater power generator comprising:
an underwater turbine;
a meter for acoustically measuring a water velocity and direction profile at various depths;
a meter for measuring turbine load or output;
a meter for measuring turbine speed; and
a data processing apparatus comprising a central processing unit (CPU), a memory operably connected to the CPU, the memory containing a program adapted to be executed by the CPU, wherein the CPU and memory are operably adapted to receive information from the water flow profile meter, the turbine load or output meter, the turbine speed meter, and implement an instruction to control operation of the turbine.

24. A data processing apparatus for controlling operation of an underwater power generator comprising:
a central processing unit (CPU); and
a memory operably connected to the CPU, the memory containing a program adapted to be executed by the CPU, wherein the CPU and memory are operably adapted to receive information on an activity affecting operation of a turbine associated with the power generator and send an instruction to alter the operation of the turbine; wherein the information on the activity affecting operation of the turbine is selected from the group consisting of: data from an ADCP current profiler; data from a thermocouple for measuring the temperature of a motor or generator, or generator hydraulic oil; data relating to tides from a network and combinations thereof.

25. A data processing apparatus for controlling operation of a an underwater power generator comprising:
a central controller including a central processing unit (CPU) and memory operably connected to the CPU;
at least one terminal, adapted for communicating with the central controller for transmitting information on activity of a water turbine associated with the power generator;
wherein the memory in the central controller contains a program adapted to be executed by the CPU, for receiving information on an activity affecting operation of a turbine and sending an instruction to the terminal to alter the operation of the turbine; and the information on the activity affecting operation of the turbine is selected from the group consisting of: data from an ADCP current profiler; data from a thermocouple for measuring the temperature of a motor or generator, or hydraulic oil; data from a network relating to local tides and combinations and combinations thereof.

26. A method for controlling operation of an underwater power generator with the aid of a computer comprising:
receiving information on an activity affecting operation of a turbine associated with the power generator;
analyzing the received information; and
sending an instruction based on the received information to alter the operation of the turbine wherein the information on the activity affecting operation of the turbine is selected from the group consisting of: data from an ADCP current profiler; data from a thermocouple for measuring the temperature of a motor, generator or hydraulic oil; data from a network relating to local tides; and combinations thereof.

27. A computer readable memory, encoded with data representing a programmable device for operation of an underwater power generator, comprising:
one or more ports for receiving information on an activity affecting operation of a turbine associated with the power generator;
a CPU for analyzing the received information; and
one or more ports for sending an instruction based on the received information to alter the operation of the turbine wherein the information on the activity affecting operation of the turbine is selected from the group consisting of: data from an ADCP current profiler; data from a thermocouple for measuring the temperature of a motor or generator or hydraulic oil; data from a network relating to load tides and combinations thereof.

28. A computer program element comprising a computer program code to make a programmable device:
receive information on an activity affecting operation of an underwater power generator;
analyze the received information; and
send an instruction based on the received information to alter the operation of a turbine associated with the underwater power generator; wherein the information on the activity affecting operation of the turbine is selected from the group consisting of: data from an ADCP current profiler; data from a thermocouple for measuring the temperature of a motor or generator, or hydraulic oil; data from a network relating to local tides; and combinations thereof.

29. A method of generating power from flow of water comprising:
installing a water turbine in a region having flowing water;
providing the system for controlling operation of an underwater power generator according to claim 1 or 2;
allowing flow of water to turn a turbine; and
altering the power output of the water turbine using the controlling system to produce electricity from the water turbine.
